(19) United States
(12) Patent Application Publication
(10) Pub. No.: US 2026/0044797 A1
(43) Pub. Date: Feb. 12, 2026

(54) Intelligent Hospitality Management Systems and Methods

(71) Applicant: Hyper Nimbus, Inc., Stone Mountain, GA (US)

(72) Inventors: Vaughn Pierre Davis, Santa Clarita, CA (US); Andy Xi-Yu Zhang, Los Angeles, CA (US)

(73) Assignee: Hyper Nimbus, Inc., Stone Mountain, GA (US)

(21) Appl. No.: 19/289,625

(22) Filed: Aug. 4, 2025

Related U.S. Application Data
(60) Provisional application No. 63/682,191, filed on Aug. 12, 2024.

(51) Int. Cl. G06Q 10/0631; G06F 40/40; G06Q 30/015; G06Q 30/0202; G06Q 50/12; G06V 10/70; G06V 20/52

(52) U.S. Cl. CPC G06Q 10/06313; G06Q 30/015; G06Q 30/02022; G06Q 50/12; G06F 40/40; G06V 10/70; G06V 20/52

(57) ABSTRACT

The disclosure relates generally to an intelligent interactive platform based on Artificial Intelligence (AI) and Machine Learning (ML) components for adaptively and selectively invoking multiple virtual agents for service and service management optimization. This disclosure particularly adapts such an intelligent system to a context of hospitality service provisioning and optimization. A Virtual Agent Coordination Engine (VACE) based on a plurality of language/voice/image models is disclosed for decomposing free-form requests from customers and service personnels via a variety of access applications into request items and for adaptively selecting a subset of virtual engines to handle the requests according to the request items. The VACE is further configured to aggregate outputs from the subset of virtual agents to intelligently generate a plurality of answers/alerts/prompts/action triggers, again, based on a plurality of AI/ML models.

### RELATED APPLICATIONS

This application is based on and claims the benefit of priority to U.S. Provisional Patent Application No. 63/682,191, filed on Aug. 12, 2024, which is incorporated by reference in its entirety.

### TECHNICAL FIELDS

The disclosure relates generally to an intelligent interactive platform based on Artificial Intelligence (AI) and Machine Learning (ML) components for adaptively and selectively invoking multiple virtual agents for service and service management optimization. This disclosure particularly adapts such an intelligent system to a context of hospitality service provisioning and optimization.

### BACKGROUND

Many types of customer service and management tasks are traditionally provided via collaboration of human agents and/or management personnel who manually interact with one another and/or manually interact with other computerized tools and data sources. Such manual coordination is inefficient and leads to under-utilization of a variety of resources, which inadvertently affects guest experience.

### SUMMARY

The disclosure relates generally to an intelligent interactive platform based on Artificial Intelligence (AI) and Machine Learning (ML) components for adaptively and selectively invoking multiple virtual agents for service and service management optimization. This disclosure particularly adapts such an intelligent system to a context of hospitality service provisioning and optimization. A Virtual Agent Coordination Engine (VACE), based on a plurality of language/voice/image models is disclosed for decomposing free-form requests from customers and service personnels via a variety of access applications into request items and for adaptively selecting a subset of virtual engines to handle the requests according to the request items. The VACE is further configured to aggregate outputs from the subset of virtual agents to intelligently generate a plurality of answers/alerts/prompts/action triggers, again, based on a plurality of AI/ML models.

In some example implementations, a method performed by an interactive electronic system is disclosed. The method may include, comprising: receiving a query from one of a plurality of access interfaces of the interactive electronic system; converting the query into multiple features using at least one trained Artificial Intelligence (AI) or Machine Learning (ML) model; selecting a plurality of virtual agents according to the multiple features; generating a plurality of subqueries corresponding to the plurality of virtual agents from the multiple features; invoking the plurality of virtual agents to process the plurality of subqueries respectively to generate a plurality of data streams; aggregating the data streams and converting the aggregated data streams into a plurality of components of a multi-component response to the query, each of the plurality of components comprising an answer, a prompt, an alert, a report, or an action trigger; and automatically dispatching the plurality of components of the multi-component response to one or more target users via one or more of the plurality of access interfaces.

In some other example implementations, a computer system is disclosed. The computer system may include a memory for storing instructions and at last one processor configured to execute the instructions to: receive a query from one of a plurality of access interfaces to the computer system; convert the query into multiple features using at least one trained Artificial Intelligence (AI) or Machine Learning (ML) model; select a plurality of virtual agents according to the multiple features; generate a plurality of subqueries corresponding to the plurality of virtual agents from the multiple features; invoke the plurality of virtual agents to process the plurality of subqueries respectively to generate a plurality of data streams; aggregate the data streams and converting the aggregated data streams into a plurality of components of a multi-component response to the query, each of the plurality of components comprising an answer, a prompt, an alert, a report, or an action trigger; and automatically dispatch the plurality of components of the multi-component response to one or more target users via one or more of the plurality of access interfaces.

In any one of the example implementations above, the query comprises a free-form text, a speech, or an image.

In any one of the example implementations above, the at least one trained Al or ML model comprises one or more of a language model, an imaging processing model, or a speech recognition model.

In any one of the example implementations above, the plurality of access interfaces comprise one or more of a mobile application, a web browser, a text messaging application, a telephone interface, a camera, a magnetic or RF reader.

In any one of the example implementations above, the interactive electronic system is configured for provisioning and managing a hospitality service.

In any one of the example implementations above, at least one of the plurality of virtual agents is configured to perform functions of a human agent counterpart of the hospitality service.

In any one of the example implementations above, at least one of plurality of virtual agents is configured to perform functions of managing personnel of the hospitality service.

In any one of the example implementations above, at least one of plurality of virtual agents is configured to perform functions of a department of the hospitality service.

In any one of the example implementations above, at least one of the plurality of virtual agents is configured to perform a predictive analytics of guest service preference.

In any one of the example implementations above, at least one of the plurality of virtual agents is configured to perform a future revenue optimization strategy generation for the hospitality service.

In any one of the example implementations above, the query comprises an image from a surveillance camera and at least one of the plurality of virtual agents is configured to perform slippage risk based on the image.

### DRAWINGS

For a more complete understanding of this disclosure, reference is made to the following description and accompanying drawings.

FIG. 1 shows an example request platform for intelligently and automatically selecting multiple virtual agents to handle free-form requests from a diverse set of users.

FIG. 2 illustrates an example graphic user interface for customizing a set of virtual agents from a virtual agent library to include in the intelligent request platform of FIG. 1 and to specify relationships among the set of virtual agents.

FIG. 3 illustrates an example Virtual Agent Coordination Engine (VACE) of FIG. 1.

FIG. 4 illustrates an example types of user application and/or devices/sensors that can interact with the intelligent request platform of FIG. 1.

FIG. 5 illustrates an example of applying the intelligent request platform of FIG. 1 to a hospitality service context.

FIG. 6 illustrates example components in a virtual agent that handles hotel reservation in the hospitality service context of FIG. 5.

FIG. 7 shows an example data flow for handling a request from management personnel when using the example intelligent request platform of FIG. 5 for service optimization.

FIG. 8 illustrates a computing component that can be used as part of a system for implementing the intelligent request platform of FIG. 1 and FIG. 5.

### DESCRIPTION OF THE DISCLOSURE

Various example implementations will now be described in detail hereinafter with reference to the accompanied drawings, which form a part of the present disclosure. The systems, devices, and methods disclosed herein may, however, be embodied in a variety of different forms and, therefore, the disclosure herein is intended to be construed as not being limited to the embodiments set forth below. Further, the disclosure may be embodied as methods, components, and/or platforms in addition to the disclosed devices and systems. Accordingly, embodiments of the disclosure may, for example, take the form of hardware, software, firmware or any combination thereof.

In general, terminology may be understood at least in part from usage in its context. For example, terms, such as “and”, “or”, or “and/or,” as used herein may include a variety of meanings that may depend at least in part upon the context in which such terms are used. Typically, the term “or”, if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for the existence of additional factors not necessarily expressly described, again, depending at least in part on context.

Many other modifications of the implementations above may be made to adapt a particular situation or material to the teachings without departing from the scope of the current disclosure. Therefore, it is not intended that the present methods and systems be limited to the particular embodiments disclosed, but that the disclosed methods and systems include all embodiments falling within the scope of the appended claims.

By way of introduction, many types of services in various business context may be rendered to customers via a plurality of human agents of different expertise. Each of such human agents may be responsible for one or more particular aspects of the services. A customer may interact with one or more different human agents to obtain services. The Human agents may interact with one another in responding to customer requests. A customer may proactively select or be manually directed to one or more proper agents for obtaining services or answers to a request.

An example can be found in hospitality industry that provides, for example, hotel services to customers. Human agents involved in providing such hospitality services may perform various functions including but not limited to room reservation, front desk functions, housekeeping, inventory management, restaurant/bar service, concierge functions, security management, parking, and the like. Some of these functions may be performed as part of guest services. Some other functions may be performed internally for human agents from one department to provide information and/or assistance to human agents of another department.

Guest experience with respect to the services above may be negatively impacted to the extent that these different functions are attributed to various human agents and performed via manual selection by guests (actual or potential) or manual redirection between the human agents. Business optimization likewise may be negatively impacted to the extent that the information/reporting and flow among management personnels depends, at least partially, on manual operations. For example, a manual process involving answering a question from a guest by assembling information items provided from multiple different types of human agents may become significantly inefficient and error-prone, and thus detrimental to guest experience. Inefficiency may also occur when a request from a guest or another internal agent requires/triggers actions by multiple different types of agents and such actions may not be sufficient conveyed to relevant parties relying on manual interaction between human agents.

The various s example implementations below provide an intelligent service/management platform that hosts the various service functions as virtual agents. These virtual agents may be based on pre-trained Artificial Intelligence (AI)/Machine Learning (ML) models that can be continuously retrained or updated according to usage and user feedback/reinforcement. The intelligent service/management platform may further include a smart virtual agent coordination engine (VACE) that intakes and automatically breaks down free-form user inputs to intelligently select a collection of one or more virtual agents, and aggregate outputs from the one or more virtual agents to automatically generate alerts, prompts, reports, and other messages to relevant parties, and triggers automatic fulfillment tasks such as reservation, service orders, inventory replenishment, and the like. In another aspects, the VACE may further automatically configure the various virtual agents to generate periodic reports, forecasts, strategies for business optimization, and the like without being prompted by a particular request or prompt from customers or service/management personnel.

The various virtual agents above may be customizable and added to the intelligent service/management platform. A small amount of training data may be provided for an initial automatic training of the virtual agents. Such newly added virtual agents may be improved through usage and user feedback by reinforcement training. The VACE may be trained by reinforcement in a similar manner.

In some other example implementations, a graphical user interface may be provided for the creation and customization of the virtual agents. A drag-and-drop approach may be employed for customizing relationships between the virtual agents. For example, a graphic user interface may be provided for user selection of a subset of types of virtual agents as icons from a library of agents according to the characteristics of a particular service being provided. The AI/ML modules employed in these virtual agents may be predefined or may be automatically selected according to the customized definition/selection and the customized relationships between the agents. Such agents and their relationships may be represented by a knowledge graph in the backend. The knowledge graph may be ingested when building the internal components of the virtual agents (e.g., selection of AI models behind each of the virtual agents).

While the various implementations summarized above and described in detail below are provided in the context of hospitality services, the underlying principles disclosed herein are not so limited and are applicable to other multi-agent contexts.

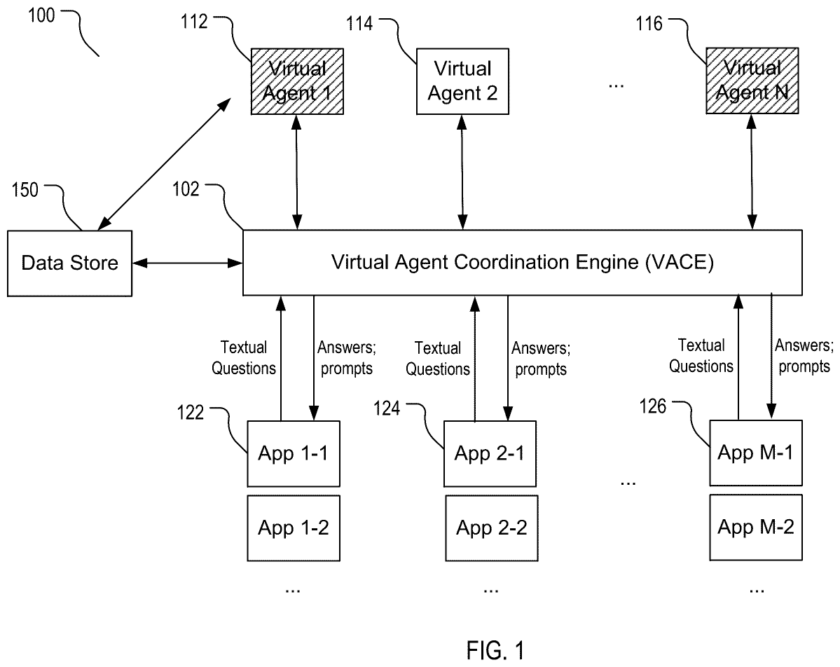

FIG. 1 illustrates an example intelligent service/management platform 100. The intelligent service/management platform 100 may include a Virtual Agent Coordination Engine (VACE) 102 in communication with a plurality of virtual agents 112, 114, . . . , and 116, labeled as Virtual Agent 1, Virtual Agent 2, and Virtual Agent N (N being a positive integer), respectively. The VACE 102 further interacts with a plurality of applications 122, 124, and 126. As further shown in FIG. 1, the VACE 102 additionally communicates/interacts with a datastore 150, which also provides data support to the virtual agents 112, 114, and 116.

In some example implementations, each of the virtual agents 112, 114 and 116 may be configured to perform a certain service function or a set of service functions. Each of these virtual agents may be configured to inject an input in a predefined or free-form data format (e.g., free-form text) and generate an output associated with the corresponding service function based on the input. The output may also be in a predefined or free-form data format (e.g., free-form text) or as a report.

The virtual agents (service or management functions) may be conveniently constructed to correspond to human agents that may be assigned to assist with the service or management functions, such that these virtual agents effectively serve as digital twins of the human agents. The collection of types of virtual agents available in the service/management platform 100 may be customized or may be selected from a virtual agent library. The manner in which the selection is made and customized for a particular service platform is described in further detail below.

The virtual agents may be related to one another. Such relationships may be captured and recorded in the datastore 150. The relationships may or may not exist between any two of the virtual agents. The relationships, for example may depend on the functional dependency between the virtual agents, similar to the functional relationships and dependency between their human agent counterparts.

The relationships may be categorized into a set of types. A relationship may be between a subject virtual agent and an object virtual agent. As such, the virtual agents and their relationships may be represented in a graphic database as nodes and edges. Data items in such a graphic database may be converted into an embedding space to explore hidden relationships and for generating new virtual agents that can be added to the library (equivalent to creating new human agent roles).

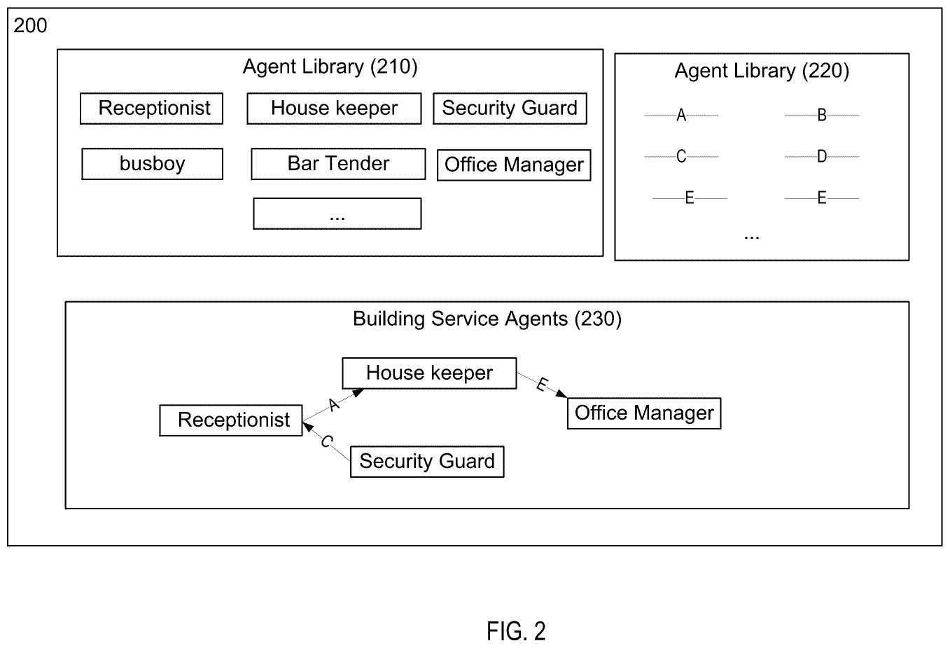

For a customization of the set of virtual agents for a particular service/management platform, a separate tool may be implemented to provide a graphic user interface as shown by 200 in FIG. 2 as an example, where a library 210 of virtual agent types are provided. A user (e.g., the service management team) is allowed to select from the library a set of virtual agents in order establish a customized set of virtual agents that form the group of virtual agents 112 through 116 of FIG. 1. A shown in FIG. 2, the candidate virtual agents may be shown as icons in the library 210. A separate library 220 may also provide candidate relationships. The user may be allowed to drag and drop selected virtual agents and relationships as connectors between virtual agents into an agent building area 230 in the graphic user interface. Once the set of agents are selected and with their relationships specified, the final set of virtual agents with relationships may be stored in the graphic database and used as virtual agent 112 through 116 of FIG. 1. In such a manner, the service/management platform can be specifically adapted and tailored to a particular service/business.

In some other example implementations, templates of virtual agents and their relationships may be provided for user selection. A user may be allowed to modify a selected template in order to customize the virtual agent selection.

Each of the virtual agents above may include one or more AI/ML models and/or one or more rule-based data processing pipelines. Such AI/ML models may again be selected from another AI model library and configured to particularly perform the data processing functionalities of the virtual agent. These AI/ML models may be pretrained. Input to each of these virtual agents may be of a predefined data format or a free-form data (such as a segment of text).

Some of the virtual agents may be function oriented and my not need to be tied to a particular human agent counterpart. For example, a virtual agent may be configured to perform or support a particular task or function, which may be a component of what a human agent counterpart performs.

As further shown in FIG. 1, access applications (or application, for simplicity) may be provided for accessing the VACE. A user of the intelligent service/management platform 100, either an actual/potential customer or an internal employee or management personnel may gain access to the platform via one or more of these applications and may input questions, voices, and other forms of data or signals to the service/management platform. These applications may process such input and pass the processed input to the VACE. Likewise, these applications may receive information from the VACE in the forms of messages, alerts, answers, prompt, reports, and the like. In FIG. 1, for example, “App 1-2” represents a second instance of the first type of Application (e.g., there may be many users using a chat application).

In some example implementations, access to the platform may need to be authorized. As such, security measures such as password protection may be established for a user to access the platform. For example, a user, such as an internal employee may be assigned an account and would need to log into the one or more applications in order to be authorized to access the service/management platform.

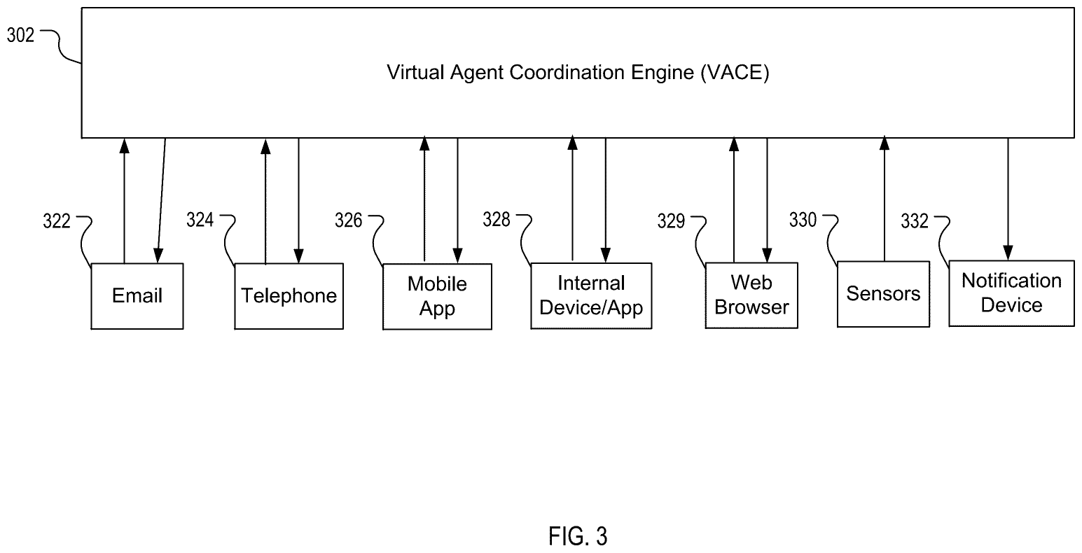

As further illustrated in the example of FIG. 3, the applications interacting with the VACE 302 may be of different types including but not limited to email apps (322), instant messaging apps (322), other mobile apps (326), telephone apps (324), internal devices/apps (328), web browser apps (329), and the like. Further, various sensors 330 may be connected to the VACE 302 as special types of applications. Such sensors may include but are not limited to cameras, magnetic scanners, RF sensors, IR sensors, Lidars, and the like. In some implementations, these sensors may be configured to provide detected signal/data to the VACE and may not need to receive anything from the VACE (as shown by the single-directional arrow from 330 to 302 in FIG. 3) (even though in some situations, monitoring triggering may be provided to these sensors from the VACE). In some example implementations, notification devices 332 may be connected to the VACE 302 as other special types of applications, such as pagers, alarms, and the like. These devices may only receive notification information, alert, or prompt from the VACE as shown by the single direction arrow from the VACE 302 to the notification device application 332.

Returning to FIG. 1, the VACE 102 may be configured to perform the critical role of receiving request data from an application, determining virtual agents that need to be polled in order to provide comprehensive responses to the request data, processing the request data into separate inputs to the selected virtual agents (such as the shaded virtual agents of FIG. 1), invoke the selected virtual agents, receive output from the invoked virtual agents, aggregate the outputs from the selected virtual agents to form a final output, and send the final output to appropriate application(s) or users.

The VACE may include one or more AI/ML models and/or one or more rule-based data processing pipelines for processing the input data and for a selection of relevant virtual agents, and for aggregating the outputs from the selected virtual agents. Such AI/ML modes may be pretrained and may be retrained, updated or reinforcement trained based on usage of the platform and user feedback (e.g., as additional positively or natively labeled training data).

The VACE 102 for example may include AI/ML models for voice recognition, language processing and embedding (text processing), objects recognition in images, and the like.

In some example implementations, the VACE may receive an input from a user via an application. The input, for example, may be a question. In order to answer the question, the VACE may decompose the question into different components or generate additional questions or other input data to multiple selected virtual agents and aggregate the output from these virtual agents as an answers/prompts/reports/action triggers according to the question. In some example implementations, the answers/prompts/reports/action triggers may be returned to the origin user and application. In some other example implementations, the answers/prompts/reports/action triggers may be decomposed and returned to multiple different users/applications including the origin user/application. In some other implementation, the answers/prompts/reports/action triggers may be returned to one or more users/applications other than the origin user/application. For example, the output from the VACE to a question may include two or more of an answer, a prompt, a report, and a trigger for executing a transaction, which may be directed to same or different users/applications as determined by the VACE as appropriate.

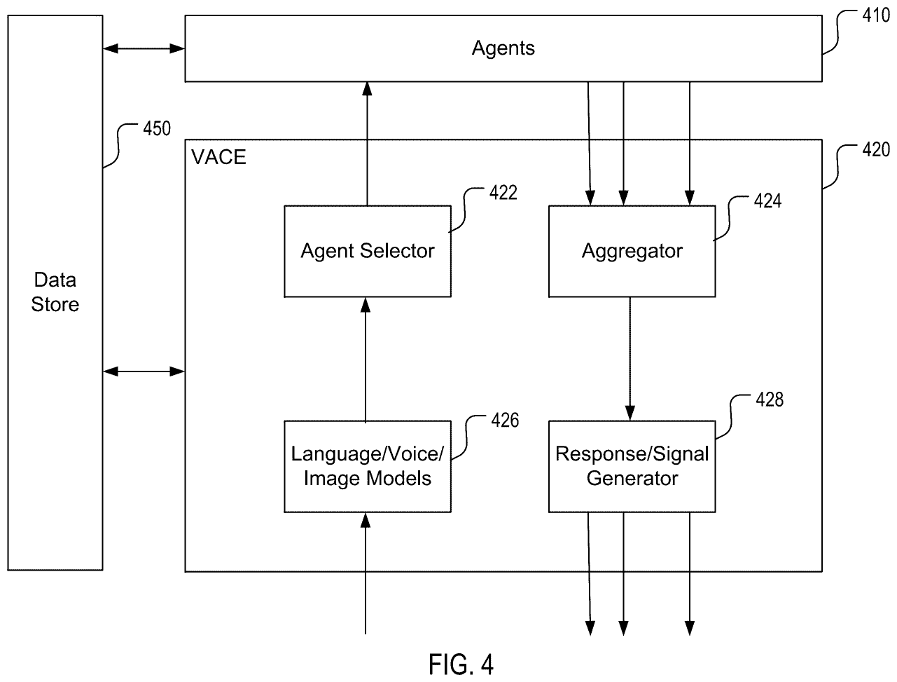

FIG. 4 shows example components of the VACE above. The VACE 420 may be configured to include an agent selector function unit 422, an aggregator function unit 424, a language/voice/image processing unit 426 and a response/signal generator 428. The language/voice/image processing unit 426 may include separate units, either in parallel or in tandem for processing voice signal or image signal into textual information, and then for processing the textual information using a language model. The language model, for example, may be trained to convert text into multi-dimensional embedding vectors. The Agent selector function unit 422 may be configured to process the output from the language/voice/image processing unit 426 to select relevant virtual agents and to provide separate input to the selected virtual agents among available virtual agents 410. The outputs from the selected virtual agents may be provided to the aggregator function unit 424, which formats the outputs from the selected virtual agents and pass the aggregated output to the response/signal generator 428, which generates one or more responses in the form of answers, alerts, prompts, reports, or action triggers, and determines which users/applications should each of these responses be directed to.

Returning to FIG. 1, the datastore 150 may include private business, organizational, customer, and other data. The datastore 150 may further include a graphic database for the available virtual agents and their relationships. Such information may be used by the VACE to select the virtual agents as additional factors besides the input data from the applications. For example, a correlation between the relationship between the virtual agents and the input data from the application may be recognized by trained AI/ML model within the VACE for selecting multiple virtual agents for a particular input data from the application.

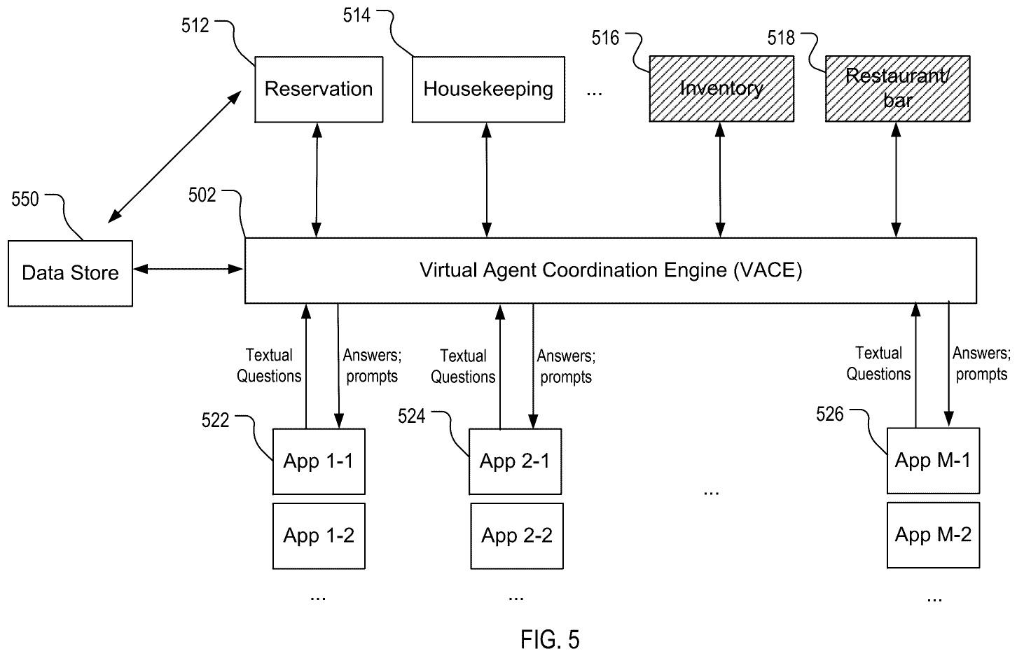

FIG. 5 shows an example intelligent service/management platform 500 in the context of hospitality services/management (hotel services/management). The platform 500 essentially includes various components similar to those of FIG. 1. The example set of virtual agents are indicated in FIG. 5 for the context of hospitality as “Reservation” 512, “Front Desk” 514, “Inventory” 516, “Restaurant/bar” 518, and the like, representing human agent counterparts for hotel services and management. Additional examples are described in further detail below.

The functioning of the service/management platform 500 is described by the example provided below. For example, a guest of the hotel, may access the platform via a chat application 522 on a mobile phone. The user may type “Can I order a bottle of Raschen Ridge 2021?” via the chat application. The VACE 502 may process the input text via its language model described above to break down this question/request into several components including but not limited to: (1) whether Raschen Ridge 2021 is carried; (2) whether it is in stock with the bar/restaurant; (4) should the inventory be replenished; (4) what is the room number for the guest for delivery; and the like. Virtual agents may be selected by the VACE to address these components of the input. The selected virtual agents, for example, may include reservation, front desk, restaurant/bar, inventory agents, and the like. The VACE may generate various responses/prompts/alerts/reports/trigger actions by aggregating the responses from the various selected virtual agents, such as sending a order request to the restaurant/bar, sending a request to the front desk to inquire room number, sending a request to inventory department, sending a response or follow up question to the guest, and the like.

As described above, special sensor applications may be configured as input to the VACE of FIG. 5. Such sensors may include but are not limited to surveillance cameras in public spaces, IR sensors, Lidars, key scanners, and the like. In one example, input from a surveillance camara may be used to automatically detect liquid spill in hallways by the VACE using object recognition algorithms. The VACE 502 may then invoke housekeeping virtual agent and dispatch instruction for cleaning.

The example platform 500 above may be accessed by different users via the various types of apps, including actual guests, potential guests, individual hospitality personnel, hospitality departments, sensors (330 of FIG. 3), and notification devices (332 of FIG. 3). As such, the example platform 500 not only enables an automatic response to guest inquiries and questions, it also provides an avenue for questions/inquires/responses for internal hospitality management purposes.

The platform above may be deployed as a single platform for managing a group of hospitality facilities. The various users may be guests or potential guests or internal personnel or departments of any of the hospitality facilities under the group. The various virtual agents above, may be configured as separate virtual agents for each of the hospitality facilities or each function may be attributed to one type of virtual agent for all the hospitality facilities. The input by the users via the applications may be generally directed to any of the hospitality facilities or a specific one. The VACE may be configured to associate the input to one or more or none of the individual hospitality facilities in the group. The output responses/answers/prompts/reports/alerts/action triggers generated from the VACE based on the outputs from selected virtual agents may likewise be associated with one or more or none of the individual hospitality facilities but may be directed to one or more users or devices (e.g., notification devices above) as appropriate.

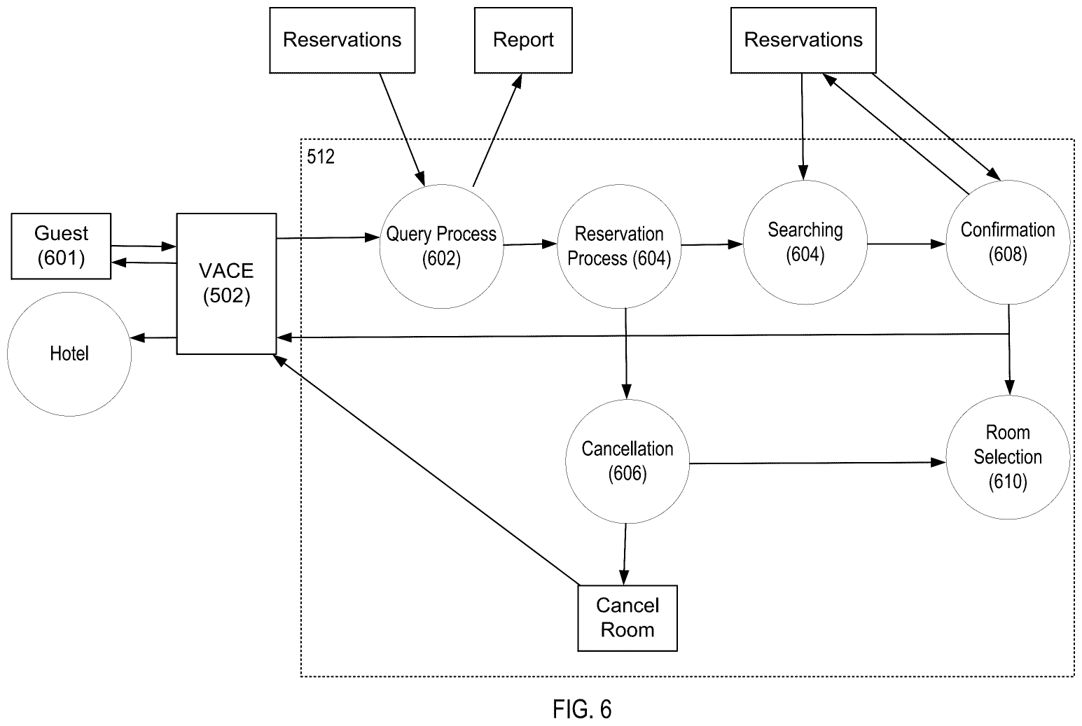

FIG. 6 further shows data processing blocks for an example virtual reservation agent 512 of the platform 500 of FIG. 5. Inquiry from a guest 601 may be passed to the VACE 502, which selects the reservation virtual agent 512 and generates an input to the virtual agent 512. The virtual agent may communicate with reservation database to perform a query process 602 to determine the reservation status for the guests and fetch existing reservation, and then if a new reservation is needed, a reservation process 604 may invoke a cancellation of existing reservation (606) and a searching process 604 to determine a new reservation with respect to a hotel. Confirmation 608 and room selection process 610 may be further performed. Cancellation and new reservation may be passed as output of the reservation virtual agent 512 for the VACE 502 to process. Response may then be returned to reservation department of the reserved hotel.

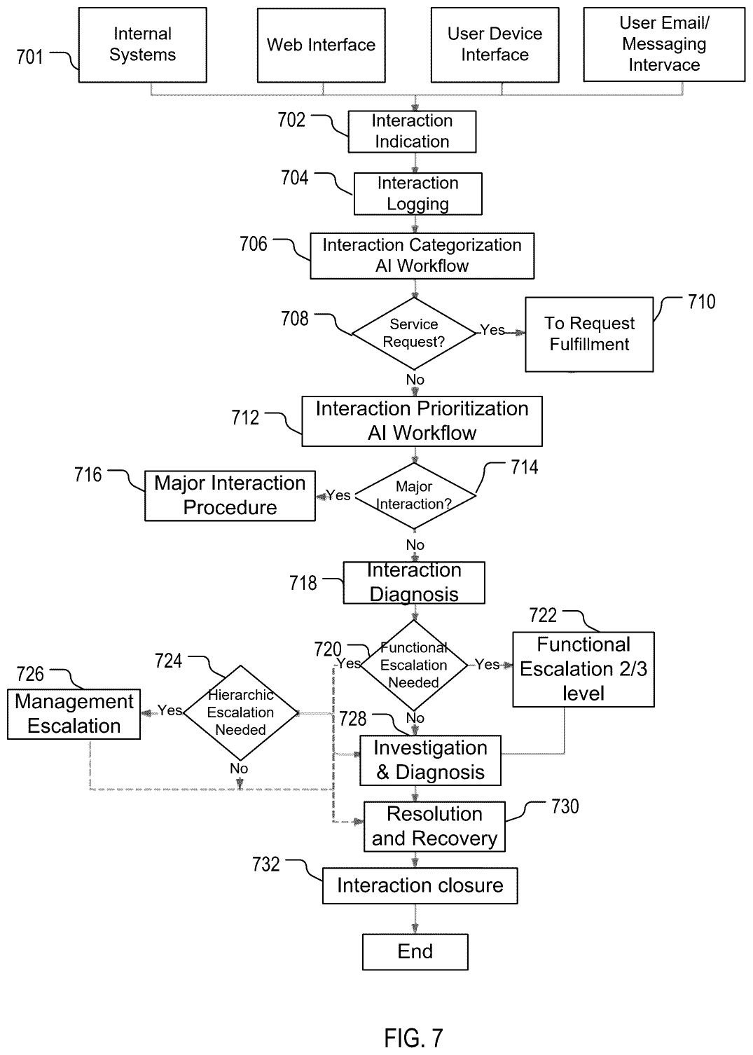

An example data and logic flow of for a process to address general interactive requests using the service/management platform above is illustrated in FIG. 7. In the example data and logic flow of FIG. 7, 701 represents the application where input from various users (e.g., service/management personnels or departments) can be obtained and provided to the VACE. Steps 702, 704, and 706 may be performed by the VACE by analyzing the input provided from the various interfaces and internal systems 701. The VACE may analyze the input to determine an interaction indication at 702, may log the interactions at 704 and may determine a category of requested interaction using for example AI/ML algorithms at 706. The VACE may further determine whether a service request is made (708) and if so, it would invoke a proper virtual agent for analyzing and fulfilling the service request (710). The further steps of FIG. 7 also be performed by the VACE described above. For example, the VACE may prioritize the interaction of it is not a service request (708 and 712), based on, for example, an AI flow. The VACE may further determine whether the interaction is a major interaction according to the priority at 714. If so, the VACE may invoke a major one or more virtual agents or real agents to perform a major interaction procedure at 716. Otherwise, the VACE may determine whether functional escalation is needed at 720. It the functional escalation is needed, the VACE may determine the escalation level (e.g., level 2 or 3) at 722 or may further determine a need for hierarchical escalation at 724 and invoke management escalation at 726. The VACE may eventually dispatch a request for investigation (728), leaving to resolution and recovery at 730 and interaction closure at 732.

The service/management platform may be adapted for internal management of the hospitality business to improve efficiency, to improve guest experience, to provide forecast, and business strategies. The virtual agents described above may be adapted to perform the processing and predictions or forecasts of various information need for the management purposes above. The users of the platform would then expand or be confined to the hospitality service/management personnels or departments. The various functionalities, inputs, and outputs of example virtual agents or components of the VACE are described in further detail below.

For example, the above intelligent service/management platform may be used as a unified Property Management System (PMS). For example, real-time room management may be performed, including but not limited to dynamic updates of room statuses, maintenance requests, and housekeeping schedules to optimize operations and guest satisfaction. For another example, financial management may be performed via inquiry and answer by the intelligent service/management platform above. Specifically, comprehensive tools for handling all financial aspects including invoicing, payment processing, and revenue tracking can be implemented as one or more virtual agents. One or more of these components may be integrated into one or more virtual agents above or as part of the VACE above.

In the above intelligent service/management platform, AI/ML driven guest personalization may be implemented. For example, predictive guest profiling may be performed which may utilize AI/ML to analyze past behavior and predict future needs, allowing for personalization of services and amenities. Further, Context-Aware Recommendations may be implemented where AI/ML algorithms may be incorporated to provide guests with suggestions for services, activities, and promotions based on real-time data such as weather, local events, or guest mood. Seamless experience may be provided across devices and applications to ensure a consistent and personalized guest experience across all digital touchpoints, including but not limited to mobile devices, desktop devices, and in-room technologies. One or more of these components may be integrated into one or more virtual agents above or as part of the VACE above.

The above intelligent service/management platform may be further configured to provide advanced Customer Relationship Management (CRM) integration. For example, deep learning customer insights may be generated leveraging AI/ML to extract deep insights from large datasets, enabling targeted marketing and loyalty programs that resonate with individual preferences. For another example, automated communication engine may be implemented to use natural language processing to manage and automate guest communications, ensuring timely and relevant interactions. For yet another example, feedback and reputation management may be implemented to automatically gather and analyze guest feedback across various platforms to improve service quality and respond proactively to guest concerns. One or more of these components may be integrated into one or more virtual agents above or as part of the VACE above.

The above intelligent service/management may be implemented to achieve operation intelligence, e.g., to optimize resource allocation, reducing costs while enhancing guest experience. For example, predictive maintenance may be implemented to predict and preemptively address maintenance issues relying on loT devices and data integration, minimizing disruptions to guest comfort. As described above, these loT devices may communicate with the VACE and various virtual agents to achieve the preemptive maintenance functions.

The above intelligent service/management may be implemented to provide a security and compliance framework. For example, advanced data encryption and security protocols may be employed to ensure the data security, including compliance with General Data Protection Regulation (GDPR) and other regulations. For another example, smart access controls may be implemented, including biometric verification and smart access systems for enhanced security and user authentication.

The above intelligent service/management may be implemented to achieve a scalable architecture and API Integration with modular design and a modular architecture that allows hotels to customize and scale solutions according to their specific needs, and with open API implementation that provide robust API support for seamless integration with third-party vendors, other hotel systems, and emerging technologies.

The above intelligent service/management may be implemented to include AI/ML-enhanced Reporting and analytics, including being equipped with dynamic reporting tools that provide real-time analytics and reports, and with AI/ML models to analyze trends and provide forecasts.

The above intelligent service/management may be implemented a decision support system to offer executive dashboards that summarize operational, financial, and guest-related data to aid strategic decision-making.

The above intelligent service/management may be implemented to provide training and support of personnel. For example, AI/ML-driven training module may be used to create dynamic training programs for hotel staff, adapting learning content to optimize staff performance and service delivery. For another example, 24/7 AI/ML-powered virtual support: may be implemented, based on the platform above, which may be capable of addressing and resolving operational, technical, and guest-related queries in real-time.

The above intelligent service/management may further be implemented for revenue management. For example, virtual agents may be designed to perform pro forma financial projections. Such virtual agents may be invoked periodically, e.g., annually, to perform and generate the projections. A general manager of the hotel may select and create pro forma financial forecasts annually or for a number of times per year. The platform above may be configured to automatically assign the request to the designated virtual agents or actual representative(s) (i.e. the operations manager, or finance person or their virtual agent counterparts). The platform may be configured to create two versions of a pro forma financial projection with detailed explanations of why it chose the data it did. The pro-formas may then be made available to the designated representatives in a dashboard, where they can review, edit, and approve the projections. Such revenue management may be performed by one or more virtual agents described above.

Data for facilitating such revenue management functions may be managed by the datastore above. Such data may include financial data such as financial statements, detailed income statements, balance sheets, and cash flow statements from previous years. Such financial data may further include top line revenue data (from room, food & beverage, other services) and operational costs. Such data may further include a comparison of actual revenue with forecasted revenue for the same periods. Such financial data may further include expense data including but not limited to detailed records of all operating expenses, including utilities, maintenance, staff salaries, marketing costs, and the like. Such financial data may further include capital expenditure such as past and planned capital expenditure for property improvements, expansions, or major purchases and vendor price increases.

Data for facilitating such revenue management functions may include operational data such as historical occupancy data, e.g., averaged daily rate (ADR), and revenue per available room (RevPAR). Such operational data may further include seasonal variations data indicating seasonal fluctuations in business. Such operational data may be provided by market intelligence tools (e.g., STR Report, RateShopping Tools, CompSet established by a bank). Such operational data may further include ADR/RevPAR/occupancy index that may be provided by, for example, Opera, Muse, CloudBeds, and the like.

Data for facilitating such revenue management functions may include guest segmentation data based on behavior, booking channels, and revenue contribution. Tailoring strategies to different segments may be implemented in one or more virtual agents to maximize revenue from high value guests by breaking down revenue generation and bookings by different customer segments (e.g., corporate, leisure, group, direct online bookings, travel agency bookings).

Data for facilitating such revenue management functions may further included partner channel performance data. Such data may facilitate evaluation of the performance of various booking channels (direct, OTAs, GDS, etc.) to optimize channel mix and reduce distribution costs. For example, such data may include information associated with Travel partner accounts, such as Online Travel Agencies (OTAs) like Booking.com, Expedia, corporate booking tools and accounts, group and event booking platforms, direct booking channels (hotel's website and reservation center), and the like.

Data for facilitating such revenue management functions may further include market trends and local economic data, such as Local events, holidays, weather or seasonal trends that could affect demand, and economic indicators that might influence travel patterns. Such data may be obtained by various components of the platform above (including the virtual agents) via weather APIs, Local Tourism Boards/government entities, event calendars, and the like. Economica data may be extracted from Duetto, Demand360, Prio, Hotelligence, quarterly stock projections, PredictHQ, Intouch Data, MEWS, Amazon (forecasting tool), HVS, Ideas, Revpar Guru, HospitalityNET, Cornell university reports, Forbes Travel Guides, Skift, and the like. Economic data may further include minimum wages, inflation rates, regulatory and tax rules, property taxes information and regulatory changes, and the like.

Data for facilitating such revenue management functions may further include vendor and supply chain data such as vendor pricing for current and projected pricing from vendors, especially for key supplies in food and beverage operations and housekeeping. Such data may further include supply chain dynamics information on any risks or expected changes in the supply chain that could affect costs or operations. Vender contracts may further be saved in the datastore above, e.g., in the cloud storage.

The platform above may be further configured to perform revenue management functions above (e.g., by one or more virtual agents, or by the VACE after aggregating outputs from multiple virtual agents) with respect to revenue maximization strategy. The platform above may be configured to output such strategies periodically, e.g. weekly.

In some example implementations, one or more buttons at the user interface of a management application connecting to the platform above may be provided for the operations team to request periodic (e.g., weekly) revenue maximizing strategies. The VACE above may then determine and utilize various virtual agents and other components to intelligently identify areas of underperformance and opportunities to increase revenue. It may be configured to generate a report with recommendations for improving proving revenue for the next week that are sent to the operations team to review/edit/approve.

Example AI/ML tasks that may be used for generating the revenue maximization strategies may include but are not limited to performance analysis AI/ML that compares actual revenue against forecasts and historical data; demand forecasting AI/ML that uses predictive analytics to forecast demand for the upcoming week; price optimization AI/ML that suggests dynamic pricing strategies based on demand predictions and comp set analysis; segmentation strategy AI/ML that analyzes which customer segments are most profitable and suggest targeted marketing strategies; operational recommendation AI/ML that identifies potential operational improvements that can enhance guest experience and drive upsell/cross sell opportunities.

Input data for revenue maximization strategy generation may include previous week's revenue performance including detailed breakdown of revenue streams (from room, food, beverage, and other services), operational costs, and comparison with the forecasted revenue for the same period, as extracted from a Property Management System (PMS)/accounting and Point of Sale (POS) systems.

Input data for revenue maximization strategy generation may further include current booking trends obtained by analyzing current booking pace, cancellation rates, and length of stay trends. This helps in understanding demand patterns and adjusting pricing strategies accordingly. Such data may further include room availability and forecasted occupancy, and upcoming events or promotions within the hotel. Such data may be extracted from a Global Distribution System (GDS), such as SABRE, Synnxis, TravelClick, CloudBeds, Salesforce, proprietary CRMs, ProfitRoom, SmartHost, GMBH, DailyPoint, BookBoost AB, Amadeus, or third-party travel partner accounts (Expedia, Booking, etc.). Such data may also be derived from events, such as from Wedding Wire, cvent, HotelEngine, CCC, 7Rooms, Airtable, Salesforce, Wix, Monday.com, Honeybook. Such data may be further derived from a Central Reservation System (CRS) and PMS.

Input data for revenue maximization strategy generation may further include competitive set analysis such as benchmarking against the competitive set (comp set) to understand the hotel's market position in terms of occupancy, ADR, and RevPAR. Such data may be extracted from market intelligence tools (e.g., STR Report, RateShopping Tools, and CompSet established by the bank). Such data may further include ADR/RevPAR/occupancy index such as extracted from Opera, Muse, CloudBeds, as described above.

Input data for revenue maximization strategy generation may further include guest segmentation data which segment guests based on behavior, booking channels, and revenue contribution. Tailoring strategies to different segments can maximize revenue from high value guests by a breakdown of revenue and bookings by different customer segments (e.g., corporate, leisure, group, direct online bookings, travel agency bookings). Such data may be extracted from a Customer Relationship Management (CRM) system.

Input data for revenue maximization strategy generation may further include partner channel performance data for evaluating the performance of various booking channels (direct, OTAs, GDS, etc.) to optimize channel mix and reduce distribution costs. Such data may be extracted from travel partner account such as Online Travel Agencies (OTAs) like Booking.com, Expedia, corporate booking tools and accounts, group and event booking platforms, and direct booking channels (hotel's website and reservation center).

Input data for revenue maximization strategy generation may further include market trends and external factors such as Local events, holidays, weather or seasonal trends that could affect demand. It may further include economic indicators that might influence travel patterns. Such information may be extracted via weather APIs, local tourism boards/government entities, event calendars, Duetto, Demand360, Prio, Hotelligence, quarterly stock projections, PredictHQ, Intouch Data, MEWS, Amazon (forecasting tool), HVS, Ideas, Revpar Guru, HospitalityNET, Cornell university reports, Forbes Travel Guides, Skift, and the like.

Input data for revenue maximization strategy generation may further include customer feedback and reviews that provide insights from customer feedback platforms and social media. Reviews from the previous week to identify areas of improvement in service or facilities that can impact revenue. Such data may be ingested and extracted from online review platforms (e.g., Yelp, TripAdvisor, Google Reviews), POS System, and/or incident logs, and the like.

Input data for revenue maximization strategy generation may further include digital analytics such as analyzed website traffic, conversion rates, and user behavior to optimize the direct booking experience and reduce reliance on costlier distribution channels. Such data may be ingested or derived from Google Analytics, Mixpanel, Open Web Analytics, Social Media Ad data (X, TikTok, Meta, Google), and the like.

Example output of the revenue maximization function above may include a detailed report that provides (1): executive summary of key findings and overall revenue performance; (2) detailed analysis of insights into each revenue stream and customer segment; (3) recommendations of specific actions to improve revenue, such as pricing adjustments, promotional offers, or operational changes; (4) forecast of revenue for the next week based on the proposed strategies.

The platform above may be further configured to perform revenue management functions above (e.g., by one or more virtual agents, or by the VACE after aggregating outputs from multiple virtual agents) with respect to revenue forecast. Such forecast may be performed by the platform periodically (e.g., monthly).

In some example implementations, one or more buttons at the user interface of a management application connecting to the platform above may be provided for the operations team to request periodic (e.g., weekly) revenue forecast. The platform may generate a report containing recommendations for improving revenue in the upcoming month across each segment. Such a report may be sent to the operations team to review/adjust/approve. The platform may generate a forecast report for the upcoming month, including, e.g., 30, 60, and 90 day projections.

Input data for revenue forecast generation may include previous month's revenue performance such as detailed breakdown of revenue streams (e.g., from room, food and beverage, and other services), operational costs, and comparison with the forecasted revenue for the same period, as may be extracted from, for example, a Property Management System (PMS)/Accounting and POS systems.

Input data for revenue forecast generation may further include current booking trends extracted by analyzing current booking pace, cancellation rates, and length of stay trends, and pulling ADR, Occupancy Index and ADR Index. This helps understand demand patterns and adjust pricing strategies accordingly. Such data may further include room availability and forecasted occupancy, and upcoming events or promotions within the hotel. Such data may be extracted from a Global Distribution System (GDS), such as SABRE, Synnxis, TravelClick, CloudBeds, Salesforce, proprietary CRMs, ProfitRoom, SmartHost, GMBH, DailyPoint, BookBoost AB, Amadeus, or third-party travel partner accounts (Expedia, Booking, etc.), or the like. Such data may also be derived from events, such as from Wedding Wire, cvent, HotelEngine, CCC, 7Rooms, Airtable, Salesforce, Wix, Monday.com, Honeybook, and the like. Such data may be further derived from a Central Reservation System (CRS) and PMS and ADR/RevPAR/Occupancy Index such as Opera, Muse, CloudBeds, and the like.

Input data for revenue forecast generation may further include guest segmentation data which segment guests based on behavior, booking channels, and revenue contribution. Tailoring strategies to different segments can maximize revenue from high value guest by a breakdown of revenue and bookings by different customer segments (e.g., corporate, leisure, group, direct online bookings, travel agency bookings). Such data may be extracted from a Customer Relationship Management (CRM) System.

Input data for revenue maximization strategy generation may further include market trends and external factors such as local events, holidays, weather or seasonal trends that could affect demand. It may further include economic indicators that might influence travel patterns. Such information may be extracted via weather APIs, Local Tourism Boards/government entities, Event Calendars, Duetto, Demand 360, Prio, Hotelligence, quarterly stock projections, PredictHQ, Intouch Data, MEWS, Amazon (forecasting tool), HVS, Ideas, Revpar Guru, HospitalityNET, Cornell university reports, Forbes Travel Guides, Skift, and the like. Such economic information may further be extracted from CBRE Report that provides comprehensive market analysis, including supply and demand trends, and economic indicators relevant to the hospitality industry and useful for understanding broader market dynamics. Such economic information may further be extracted from STR report containing benchmarking report that compares a hotel's performance against its competitive set (comp set) with respect to key metrics include occupancy, ADR (Average Daily Rate), and RevPAR (Revenue Per Available Room). The term Comp Set (benchmarking) refers to a group of hotels that are considered direct competitors, usually similar in terms of size, quality, and market.

Input data for revenue maximization strategy generation may further include partner channel performance data for evaluating the performance of various booking channels (direct, OTAs, GDS, etc.) to optimize channel mix and reduce distribution costs. Such data may be extracted from travel partner account such as Online Travel Agencies (OTAs) like Booking.com, Expedia, corporate booking tools and accounts, group and event booking platforms, direct booking channels (hotel's website and reservation center, and the like.

The above intelligent service/management may be implemented for front office operations. For example, the virtual agent may be designed to perform service coordination and analysis of front office/housekeeping/maintenance/laundry coordination. Specifically, the platform above and the virtual agents therein may be configured to AI/ML to analyze operational data to identify bottlenecks and inefficiencies in guest services, and to suggest improvements. For example, if there is a recurring delay in room readiness post-check-out, the AI/ML functions can recommend process for optimizations or staff reallocations.

For another example, the virtual agents may be designed to perform room assignments. Specifically, the platform above and the virtual agents may be configured with AI/ML functionalities to assist in intelligently assigning rooms based on guest preferences and operational efficiency, reducing room change requests and enhancing guest satisfaction.

For another example, the virtual agents may be designed to perform feedback and reputation management, including AI/ML based sentiment analysis of guest feedback from various sources, such as social media and review platforms, to provide insights into guest satisfaction and areas for improvement. The reputation Management may involve monitoring and reporting on the hotel's online reputation by AI/ML enabled virtual agents, suggesting actions to enhance guest perception.

For another example, the virtual agents may be designed to perform staff scheduling and demand management. The staff scheduling may be dynamically implemented by using AI/ML to analyze historical data and predict busy periods, helping optimize staff schedules and ensure adequate coverage during peak times. AI/ML may be used to enhance staff scheduling based on analyzing historical data, considering factors like seasonal trends, local events, and past occupancy rates, to predict busy periods. This information helps create efficient staff schedules, ensuring the front desk is adequately staffed during peak times while avoiding overstaffing during slower periods. AI/ML may also be used for performance analytics by tracking key performance indicators (KPIs) for front desk operations and identifying patterns in staff performance. For instance, it might highlight that certain staff members excel in handling guest check-ins during rush hours or identify training gaps where additional coaching could enhance performance. Personalized Training recommendations may be generated via AI/ML based on the performance analytics above. Personalized training modules may be recommended for each staff member, focusing on areas where they can improve or expand their skills. In addition, accessible Knowledge base may be provided via AI/ML recommendation to staff with easy access to information, from hotel policies to FAQs, ensuring they have the necessary knowledge at their fingertips.

For another example, the virtual agents may be designed to perform automated financial reconciliation and reporting. The primary responsibility of such function is to review and reconcile the day's financial transactions, including room charges, food and beverage revenues, and other ancillary services. Financial reports may be generated for the previous day's business, providing a clear picture of the hotel's daily revenue and expenditures. Audit and compliance functionality may be included to ensuring that all financial transactions comply with the hotel's policies and standards. Compliance monitoring.

For another example, the virtual agents may be designed to perform vendor and partner management. Specifically, AI/ML can be employed to help manage relationships with local vendors and partners, keeping track of preferred service providers and their performance.

The above intelligent service/management may be implemented for managing guest experience. For example, the platform may be configured for managing personalized guest experience. In particular, personalized communication and services may be managed by one or more virtual agents, offering tailored recommendations, greetings, and room preferences. Targeted Upselling may also be implemented. For example, AI/ML models can be trained to identify optimal upselling opportunities based on guest history and preferences, such as room upgrades or special packages or food preferences and recommendations.

For another example, the platform may be configured to manage guest requests and manage guest issues. The platform may be configured to provide an interface for guests to submit requests/issues via a variety of applications and interfaces, as described above. The platform via the VACE provide automatic routing to relevant virtual agent and then to alert, prompt, or respond to responsible parties.

For another example, a comprehensive and up-to-date database of local attractions, events, restaurants, and other points of interest may be included in the datastore above and used by the VACE and relevant virtual agents to heil provide guests with accurate and current information. The guest may be provided with real-time updates on local events, traffic conditions, and other relevant information that could impact guest plans.

The above intelligent service/management may be implemented for managing front desk operations. For example, one or more virtual agents or other component of the VACE may be configured with AI/ML models to function as front desk agents that interact with various front desk software, thereby significantly enhancing guest service, operational efficiency, and overall hotel management. The virtual front desk agents may be configured to interact with multiple systems, such as Property Management Systems (PMS), Customer Relationship Management (CRM) tools, communication platforms, and the like.

For example, the platform above may be configured to provide a real Time operations overview, in the form of, for example, a dashboard that provides real time insights into hotel occupancy, valet and luggage requests, guest requests/issues, and the like. For another example, the platform above may be configured to provide a support chatbots as virtual assistants. For another example, the platform above may be configured to facilitate targeted upselling by the front desk in that AI/ML functionalities can be trained to prompt front desk agents with personalized upselling opportunities (such as room upgrades, amenities, services) based on guest preferences and behavior. For another example, the platform above may be configured to provide emergency and security alerts. In particular, AI/ML models may be included and configured to provide real time information and guidance to front desk agents during emergencies, ensuring that proper protocol is followed. In some implementations, automated Emergency Protocols may be prompted. In case of an emergency, the platform may be configured to automatically trigger emergency protocols, sending instructions to staff and guests. For example, in a fire emergency, it could direct guests to the nearest exits and inform staff of evacuation procedures.

The above intelligent service/management may be implemented for further manage concierge operations. For example, the platform above may be configured to provide smart and AI/ML powered concierge. For example, smart concierge may be provided by a 27/7 chatbot managed by the platform above. Such a chatbot may be configured to provide continuous, real-time interaction with guests, offering assistance, information, and services without delays. Such Chatbot may be configured with deep contextual understanding relying on advanced AI/ML to comprehend and predict guest needs based on subtle cues, past behaviors, and current contextual data. Such chatbot may be configured to perform dynamic personalization for automatically personalizing interactions and recommendations, adjusting suggestions in real-time based on guest feedback and behavior.

The platform above may be configured to perform concierge with seamless integration with a guest services department for automated service management such as handling routine requests such as towels, toiletries, room adjustments, and maintenance issues, and directly coordinating with operational teams to fulfill requests with little human intervention. The platform above may be configured to perform concierge services with proactive problem resolution such as identifying potential guest issues before they escalate and autonomously implementing solutions, and notifying human staff only when necessary.

The platform above may be configured to perform other advanced concierge services such as intelligent Itinerary planning and crafting personalized itineraries for guests based on their preferences and past likes and arranging everything from restaurant bookings to local tours. Other advanced concierge service may include managing guest event access and booking by leveraging real-time data to recommend and secure tickets for events, shows, and experiences, often achieving last-minute bookings and hard-to-get reservations through its network.

The platform above may be configured to perform front desk revolution such as AI/ML-enhanced Check-In/Out, which streamlines check-in and check-out processes, using, for example, facial recognition and predictive processing to prepare room keys and finalize bills before the guest arrives at the desk.

The platform above may be configured to perform instant guest recognition by identifying returning guests upon entry and personalizing greeting and room preferences automatically, making guests feel recognized and valued.

The platform above may be configured to perform operational optimization, such as staff task optimization so as to frees up human staff by taking over repetitive, time-consuming tasks, allowing employees to focus on providing higher-quality, personalized guest interactions.

The platform above may be configured to perform real-Time Data Synthesis by Integrating data from various hotel systems to provide staff with comprehensive insights into guest preferences and operational status.

The platform above may be configured to manage training and support such as on-demand training for staff and provide instant training and updates for new staff members, supplying them with information and protocols directly through an interactive system.

The platform above may be configured to assist in decision support for complex scenarios so as to assists human staff with complex decision-making by providing data-driven insights and recommendations.

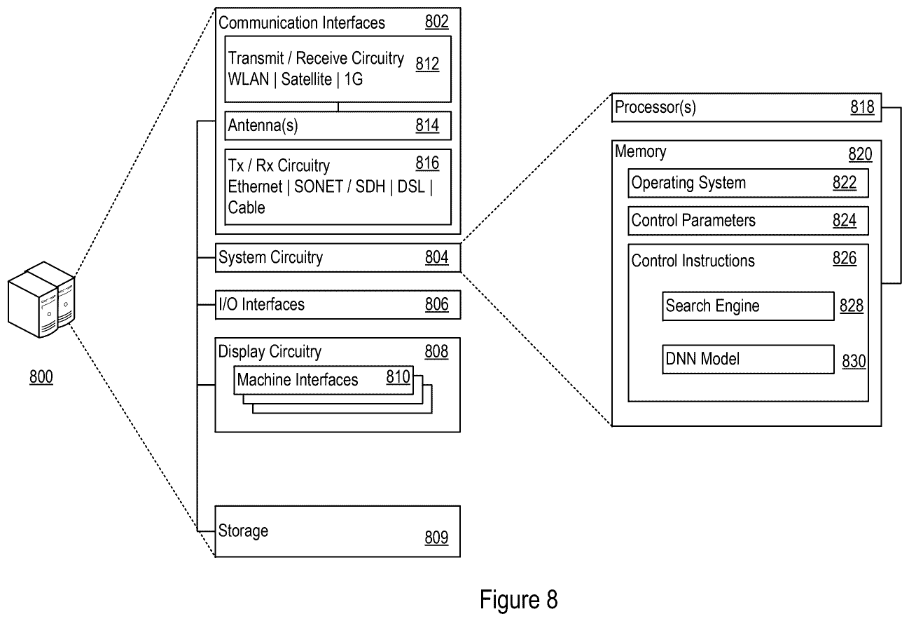

Finally, in FIG. 8, an example computing architecture 800 that may be implemented in any of the processing and storage component above is shown, including communication interfaces 802, system circuitry 804, input/output (I/O) interfaces 806, storage 809, and display circuitry 808 that generates machine interfaces 810 (such as the user interfaces described above) locally or for remote display, e.g., in a web browser running on a local or remote machine. The machine interfaces 810 and the I/O interfaces 806 may include GUls, touch sensitive displays, voice or facial recognition inputs, buttons, switches, speakers and other user interface elements. Additional examples of the I/O interfaces 806 include microphones, video and still image cameras, headset and microphone input/output jacks, Universal Serial Bus (USB) connectors, memory card slots, and other types of inputs. The I/O interfaces 806 may further include magnetic or optical media interfaces (e.g., a CDROM or DVD drive), serial and parallel bus interfaces, and keyboard and mouse interfaces.

The communication interfaces 802 may include wireless transmitters and receivers (“transceivers”) 812 and any antennas 814 used by the transmitting and receiving circuitry of the transceivers 812. The transceivers 812 and antennas 814 may support Wi-Fi network communications, for instance, under any version of IEEE 802.11, e.g., 802.11n or 802.11ac. The communication interfaces 802 may also include wireline transceivers 716. The wireline transceivers 816 may provide physical layer interfaces for any of a wide range of communication protocols, such as any type of Ethernet, data over cable service interface specification (DOCSIS), digital subscriber line (DSL), Synchronous Optical Network (SONET), or other protocol. Computers using the computing architecture of 800 may communicate with one another via the communication interface 802 and the communication network 801 as shown in FIG. 1.

The storage 809 may be used to store various initial, intermediate, or final data or model for implementing the functionalities of the knowledge pattern machine and the various other computing components described above. The storage 809 may be centralized or distributed. For example, the storage 809 may be hosted remotely by a cloud computing service provider.

The system circuitry 804 may include hardware, software, firmware, or other circuitry in any combination. The system circuitry 804 may be implemented, for example, with one or more systems on a chip (SoC), application specific integrated circuits (ASIC), microprocessors, discrete analog and digital circuits, and other circuitry. The system circuitry 804 is part of the implementation of any desired functionality related to the knowledge pattern machine. As just one example, the system circuitry 804 may include one or more instruction processors 818 and memories 820. The memories 820 may store, for example, control instructions 824 and an operating system 822. In one implementation, the instruction processors 818 may execute the control instructions 824 and the operating system 822 to carry out any desired functionality related to the functionalities of the knowledge pattern machine described above.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (and may store instructions that perform any of the processing described above or illustrated in the drawings, when executed by the circuitry.

It is to be understood that the various implementations above are not limited in its application to the details of construction and the arrangement of components set forth above and in the accompanying drawings. The disclosure is intended to cover other embodiments that may be practiced or carried out in various ways following the underlying principles disclosed herein.

It should also be noted that a plurality of hardware and software-based devices, as well as a plurality of different structural components, may be used to implement the various embodiments of the disclosure. In addition, it should be understood that embodiments of this disclosure may include hardware, software, and electronic components or modules that, for purposes of discussion, may be illustrated and described as if the majority of the components are implemented solely in hardware. However, one of the ordinary skills in the art, and based on a reading of this disclosure, would recognize that, in at least one embodiment, the electronic-based aspects of the invention may be implemented in software (e.g., stored on a non-transitory computer-readable medium) executable by one or more processors. As such, it should be noted that a plurality of hardware and software-based devices, as well as a plurality of different structural components, may be utilized to implement the invention. Furthermore, and as described in subsequent paragraphs, the specific mechanical configurations illustrated in the drawings are intended to exemplify embodiments of the invention and that other alternative mechanical configurations are possible. For example, “controllers” described in the specification can include standard processing components, such as one or more processors, one or more computer-readable medium modules, one or more input/output interfaces, and various connections (e.g., a system bus) connecting the components. These controllers may be implemented as dedicated processing circuitry or in general-purpose processors, in combination of various software and/or firmware, and in combination of other wired or wireless communication interfaces.

1. A method performed by an interactive electronic system, comprising:
receiving a query from one of a plurality of access interfaces of the interactive electronic system;
converting the query into multiple features using at least one trained Artificial Intelligence (AI) or Machine Learning (ML) model;
selecting a plurality of virtual agents according to the multiple features;
generating a plurality of subqueries corresponding to the plurality of virtual agents from the multiple features;
invoking the plurality of virtual agents to process the plurality of subqueries respectively to generate a plurality of data streams;
aggregating the data streams and converting the aggregated data streams into a plurality of components of a multi-component response to the query, each of the plurality of components comprising an answer, a prompt, an alert, a report, or an action trigger; and
automatically dispatching the plurality of components of the multi-component response to one or more target users via one or more of the plurality of access interfaces.

2. The method of claim 1, wherein the query comprises a free-form text, a speech, or an image.

3. The method of claim 1, wherein the at least one trained AI or ML model comprises one or more of a language model, an imaging processing model, or a speech recognition model.

4. The method of claim 1, wherein the plurality of access interfaces comprise one or more of a mobile application, a web browser, a text messaging application, a telephone interface, a camera, a magnetic or RF reader.

5. The method of claim 1, wherein the interactive electronic system is configured for provisioning and managing a hospitality service.

6. The method of claim 5, wherein at least one of the plurality of virtual agents is configured to perform functions of a human agent counterpart of the hospitality service.

7. The method of claim 5, wherein at least one of plurality of virtual agents is configured to perform functions of managing personnel of the hospitality service.

8. The method of claim 5, wherein at least one of plurality of virtual agents is configured to perform functions of a department of the hospitality service.

9. The method of claim 5, wherein at least one of the plurality of virtual agents is configured to perform a predictive analytics of guest service preference.

10. The method of claim 5, wherein at least one of the plurality of virtual agents is configured to perform a future revenue optimization strategy generation for the hospitality service.

11. The method of claim 5, wherein the query comprises an image from a surveillance camera and at least one of the plurality of virtual agents is configured to perform slippage risk based on the image.

12. A computer system, comprising a memory for storing instructions and at last one processor configured to execute the instructions to:
receive a query from one of a plurality of access interfaces to the computer system;
convert the query into multiple features using at least one trained Artificial Intelligence (AI) or Machine Learning (ML) model;
select a plurality of virtual agents according to the multiple features;
generate a plurality of subqueries corresponding to the plurality of virtual agents from the multiple features;
invoke the plurality of virtual agents to process the plurality of subqueries respectively to generate a plurality of data streams;
aggregate the data streams and converting the aggregated data streams into a plurality of components of a multi-component response to the query, each of the plurality of components comprising an answer, a prompt, an alert, a report, or an action trigger; and
automatically dispatch the plurality of components of the multi-component response to one or more target users via one or more of the plurality of access interfaces.

13. The computer system of claim 12, wherein the query comprises a free-form text, a speech, or an image.

14. The computer system of claim 12, wherein the at least one trained AI or ML model comprises one or more of a language model, an imaging processing model, or a speech recognition model.

15. The computer system of claim 12, wherein the plurality of access interfaces comprise one or more of a mobile application, a web browser, a text messaging application, a telephone interface, a camera, a magnetic or RF reader.

16. The computer system of claim 12, wherein the computer system is configured for provisioning and managing a hospitality service.

17. The computer system of claim 16, wherein at least one of the plurality of virtual agents is configured to perform functions of a human agent counterpart of the hospitality service.

18. The computer system of claim 16, wherein at least one of plurality of virtual agents is configured to performs functions of managing personnel of the hospitality service.

19. The computer system of claim 16, wherein at least one of plurality of virtual agents is configured to perform functions of a department of the hospitality service.

20. The computer system of claim 16, wherein at least one of the plurality of virtual agents is configured to perform a predictive analytics of guest service preference.

21. The computer system of claim 16, wherein at least one of the plurality of virtual agents is configured to perform a future revenue optimization strategy generation for the hospitality service.

22. The computer system of claim 16, wherein the query comprises an image from a surveillance camera and at least one of the plurality of virtual agents is configured to perform slippage risk based on the image.
